(19) United States
(12) Patent Application Publication
(10) Pub. No.: US 2025/0208288 A1
(43) Pub. Date: Jun. 26, 2025

(54) METHODS AND SYSTEMS FOR IMPROVING ACCURACY OF OCCUPANCY MONITORING USING MULTIPLE SENSORS

(71) Applicant: Johnson Controls Tyco IP Holdings LLP, Milwaukee, WI (US)

(72) Inventors: Brian RICH, Nashua, NH (US); Glenn Kilburn HOLTON, Braintree, MA (US); Luke RUTER, Chelmsford, MA (US); Roscell CAISSIE, Manchester, NH (US); Kartik DEVARAKONDA, Lowell, MA (US)

(21) Appl. No.: 18/391,086

(22) Filed: Dec. 20, 2023

(51) Int. Cl. G01S 13/86; G01S 7/41; G01S 13/04

(52) U.S. Cl. CPC G01S 13/865; G01S 7/412; G01S 13/04; G01S 13/867

(57) ABSTRACT

Systems and methods are disclosed for computing an occupancy count of an area based on data from multiple sensors. A first count of people in the area at a time instance can be obtained based on first data from a first sensor monitoring an entry point to the area, a second count of people in the area at the time instance can be obtained based on second data captured by a second sensor of a sensor type other than the first sensor, and the occupancy count of the area at the time instance can be computed as a sum of the first count, which may have a first weight applied, and the second count, which may have a second weight applied.

### BACKGROUND

The present disclosure relates to performing occupancy monitoring in an area, and more particularly to counting a number of humans detected in an area.

Systems exist for monitoring occupancy in certain areas of an establishment, such as rooms of indoor establishments (e.g., offices or conference rooms of office buildings), areas of outdoor establishments (e.g., sections of stadiums), etc. Some such systems use a light and detection ranging (LIDAR) sensor to detect when people enter and/or exit the area, and can maintain a count of people in the area by adding one for each person entering the area and subtracting one for each person exiting the area. LIDAR sensors may not maintain an accurate count of people, such as when power is lost and the LIDAR sensor count may reset to zero.

Other systems for monitoring occupancy can use video cameras along with computer vision to detect people present in the area. These systems may not always be desired, however, due to cost, due to intrusiveness of such systems having the ability to obtain personal identifying information (PII) (e.g., where the video can perform identification of people in the area), etc. For example, occupancy monitoring may be desired in a restroom, locker room, or other area where a level of privacy is expected; however, the presence of cameras in such areas may violate the expected privacy.

### SUMMARY

This summary is provided to introduce a selection of concepts in a simplified form that are further described below in the DETAILED DESCRIPTION. This summary is not intended to identify key features of the claimed subject matter, nor is it intended to be used as an aid in determining the scope of the claimed subject matter.

In an aspect, a method for obtaining an occupancy count of an area is provided that includes obtaining, based on first data from a first sensor monitoring an entry point to the area, a first count of people in the area at a time instance, wherein the first sensor is a light detecting and ranging (LIDAR) sensor, obtaining, based on second data captured by a second sensor of a sensor type other than LIDAR, a second count of people in the area at the time instance, and computing the occupancy count of the area at the time instance as a sum of the first count having a first weight applied and the second count having a second weight applied.

In another aspect, an apparatus including one or more memories configured to store instructions, and one or more processors communicatively coupled with the one or more memories is provided. The one or more processors are configured to obtain, based on first data from a first sensor monitoring an entry point to the area, a first count of people in an area at a time instance, wherein the first sensor is a LIDAR sensor, obtain, based on second data captured by a second sensor of a sensor type other than LIDAR, a second count of people in the area at the time instance, and compute the occupancy count of an area at the time instance as a sum of the first count having a first weight applied and the second count having a second weight applied.

In another aspect, one or more computer-readable media storing instructions, executable by one or more processors, for obtaining an occupancy count of an area, are provided. The instructions include instructions for obtaining, based on first data from a first sensor monitoring an entry point to the area, a first count of people in the area at a time instance, wherein the first sensor is a LIDAR sensor, obtaining, based on second data captured by a second sensor of a sensor type other than LIDAR, a second count of people in the area at the time instance, and computing the occupancy count of the area at the time instance as a sum of the first count having a first weight applied and the second count having a second weight applied.

In another aspect, an occupancy monitoring system is provided that includes various hardware, software, or other components for obtaining an occupancy count of an area using one or more methods described herein. In another aspects, an occupancy monitoring system is provided that includes means for obtaining an occupancy count of an area using one or more methods described herein. In another aspect, a computer-readable medium is provided herein that stores computer executable instructions for obtaining an occupancy count of an area using one or more methods described herein.

Further aspects of the present disclosure are described in more details below.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 illustrates an example of an establishment having an occupancy monitoring system, according to implementations of the present disclosure;

FIG. 2 is a schematic diagram of an example of an occupancy monitoring system and/or related components for obtaining an occupancy count of an area, according to implementations of the present disclosure;

FIG. 3 is a flowchart of an example of a method for computing occupancy count of an area based on information from multiple sensors, according to implementations of the present disclosure; and

FIG. 4 is a block diagram of examples components of a computer device that may implement one or more of the features of the occupancy sensing device of FIG. 1.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known components may be shown in block diagram form in order to avoid obscuring such concepts.

Current occupancy monitoring systems use a single sensor to detect occupancy in an area, such as a light and detection ranging (LIDAR) sensor to detect when people enter and/or exit the area, or a video camera that uses computer vision to count people in an area. Occupancy monitoring using such systems can be susceptible to error for different reasons. For example, the LIDAR sensor may reset when power is lost, and the count of people may become zeroed out, though there may be people in the room when power is lost. In another example, using computer vision to detect people in an area may not detect all of the people, such as when a person is behind another person or is otherwise not entirely visible in a captured video feed, etc. There is a need, however, to obtain an accurate count of people occupying a certain area for various purposes, such as for controlling automation systems (heating, ventilation, and air conditioning (HVAC) systems, lighting systems, access control systems, etc.), providing the information to emergency services personnel in the event of a fire, active shooter, or other disaster, etc.

The present disclosure addresses one or more shortcomings of occupancy monitoring systems by using information multiple sensors to detect a number of people in an area. For example, the occupancy monitoring system can collect occupancy monitoring information, such as a count of people in an area, from multiple sensor sources, and can combine the counts based on data from each sensor source. In an example, the occupancy monitoring system can apply a weight to one or more of the counts, which may be based on a confidence of accuracy of the given sensor in its ability to detect people in the area. For example, the weight can be determined based on a type of the sensor, a type of other sensors in the area that can also provide occupancy monitoring data, etc. In some examples, the occupancy monitoring system can provide the occupancy monitoring information (e.g., the count of people in the area), as counted by a single sensor or multiple sensors, to other systems along with a confidence level of the occupancy monitoring information. The other systems can include automation systems, emergency services systems, and/or the like, as described above and further herein.

In some examples, the sensors can include non-invasive sensors, such as a LIDAR sensor to detect when people enter or exit an area, a thermal sensor that can capture thermal images of an area without capturing specific features of people, an ultra-wide band radar that can capture depth images of an area without capturing specific features of people, etc. For thermal images and/or depth images, for example, the images can be provided to a trained artificial intelligence (AI) model to detect generic human signatures or features in the images, based on which the number of people can be counted. In this regard, the various sensors can be deployed to capture a similar area of an establishment, so that the provided occupancy monitoring information can be similar among the sensors. As described, in some examples, a weight can be applied to each count of people based on sensor type or other considerations, and the weighted counts can be combined to determine a more accurate occupancy count for the area.

In accordance with examples described herein, detecting occupancy of areas of an establishment with higher accuracy, in this regard, can provide various advantages, including controlling automation systems based on a more accurate count of people than is possible with conventional systems to allow for more accurate control of the area by the automation systems. Similarly, providing a more accurate count of people in an area can improve emergency services response or strategy for safely removing people from emergency situations in the area. Also, in some examples, providing more accurate count of people using multiple sensors can allow for more accurate statistical analysis of area usage within an establishment.

Turning now to the figures, example aspects are depicted with reference to one or more modules or components described herein, where modules or components in dashed lines may be optional.

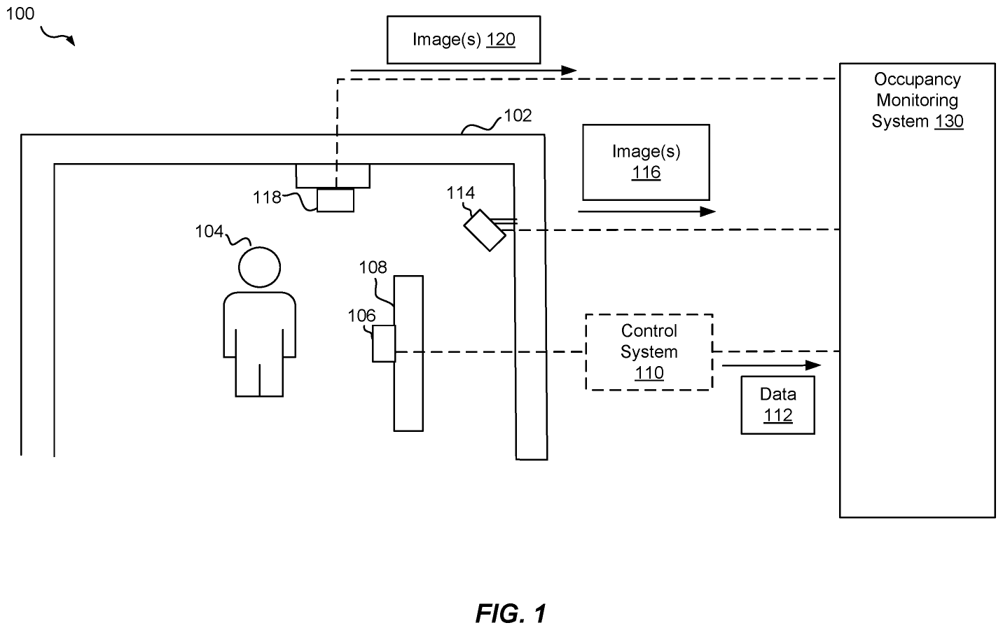

Referring to FIG. 1, an example of an establishment 100 having an occupancy monitoring system is depicted. The establishment 100 may be an indoor establishment, such as an office building, residence, etc., or an outdoor establishment, such as a stadium, amusement park, etc. The establishment 100 may have one or more areas 102, such as rooms, offices, sections, etc., for which occupancy monitoring is desired to detect a number of persons 104 in the area 102. An area 102 can include one or more sensors that can be used to facilitate occupancy monitoring, such as a sensor 106 on or monitoring an entry point 108 into the area, where the entry point may include a door, turnstile, automated gate, etc. The sensor 106 may include a motion sensor or a LIDAR sensor for detecting persons 104 entering and/or exiting the area 102. The sensor 106 can keep a count of people in the area 102 based on incrementing a count when a person 104 enters the area 102 and decrementing the count when a person 104 exits the area 102.

In some examples, the sensor 106 can be controlled by a control system 110 that can interface with a network switch. The control system 110 can control the sensor 106 and/or the entry point 108 based on data received from the sensor 106. In one example, control system 110 can keep count of the people entering and/or exiting the area 102 recognized via the sensor 106. The sensor 106 and/or the control system 110 can provide data to an occupancy monitoring system 130 for monitoring the occupancy in the area 102, such as the count of people counted by the sensor 106, as described above. The area 102 can include one or more other sensors that can also provide a count of people to the occupancy monitoring system 130 or provide data based on which the occupancy monitoring system 130 can count people in the area 102.

For example, area 102 can include a second sensor 114, which can be a non-invasive imaging sensor, such as an ultra-wide band radar sensor or a thermal sensor, which can provide image(s) 116 to the occupancy monitoring system 130 for determining a count of people in the area 102, or can otherwise determine the count and provide the count data to occupancy monitoring system 130. Similarly, in an example, area 102 can include a third sensor 118, which can be another non-invasive imaging sensor, such as an ultra-wide band radar sensor or a thermal sensor (e.g., which may be of a different type than the second sensor 114), for providing image(s) 120 to the occupancy monitoring system 130 for determining a count of people in the area 102, or otherwise determining the count and provide the count data to occupancy monitoring system 130. In accordance with aspects described herein, occupancy monitoring system 130 can fuse the sensor data 112, 116, and/or 120 received from multiple sensors 106, 114, and/or 118 to determine an occupancy count of the area 102. In an example, each of the sensors 106, 114, and/or 118 can be communicatively coupled with the occupancy monitoring system 130 either directly (e.g., using a directed wired or wireless connection to the occupancy monitoring system 130 or one or more network nodes to facilitate network connectivity, etc.) or via another control system to which the sensor is directly coupled, where the control system can be communicatively coupled with the occupancy monitoring system 130, as described, or substantially any connection between the sensors 106, 114, and/or 118 and occupancy monitoring system 130 that allows for communicating occupancy monitoring information or other data therebetween.

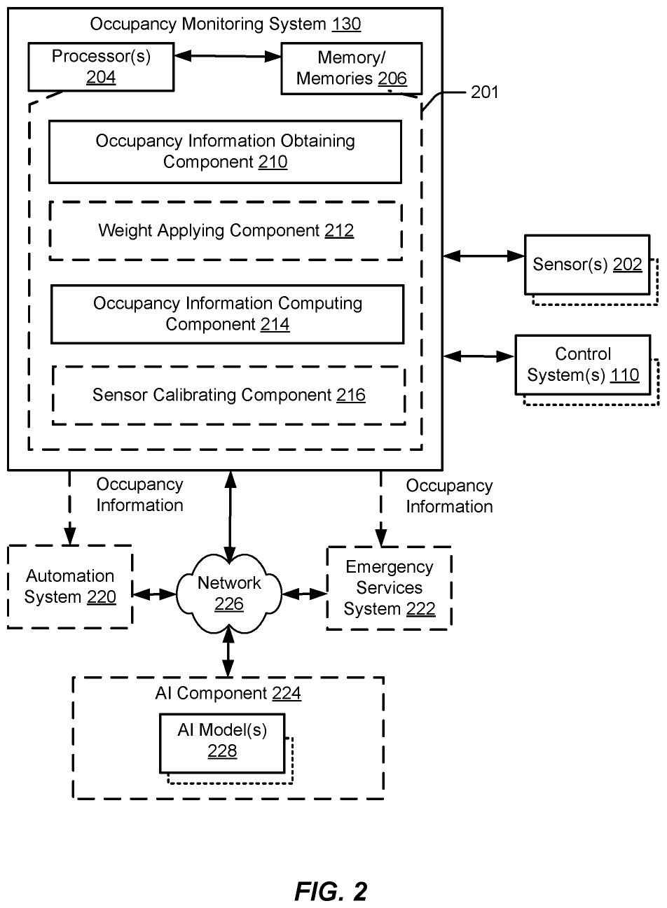

FIG. 2 is a schematic diagram of an example of an occupancy monitoring system 130 and/or related components for monitoring occupancy in an area, in accordance with aspects described herein. In an example, occupancy monitoring system 130 can receive data or images from one or more sensors 202 deployed in the area 102, from one or more control systems 110 that can operate the one or more sensors 202, to determine occupancy information, such as a count of people in the area 102, based on information obtained via the sensor(s) 202, and can aggregate the information from multiple sensors to provide a more accurate count than a single sensor may provide.

In an example, occupancy monitoring system 130 can include or can otherwise be coupled with one or more processors 204 and/or a memory or memories 206, where the processor(s) 204 and/or memory/memories 206 can be configured to execute or store instructions or other parameters related to monitoring occupancy in one or more points of interest in a room, as described herein. For example, processor(s) 204 and memory/memories 206 may be separate components communicatively coupled by a bus (e.g., on a motherboard or other portion of a computing device, on an integrated circuit, such as a system on a chip (SoC), etc.), components integrated within one another (e.g., processor(s) 204 can include the memory/memories 206 as an on-board component 201), and/or the like. In another example, processor(s) 204 can include multiple processors on different distributed computing resources (e.g., in cloud-based computing architecture). In an example, memory/memories 206 can include multiple memories on different distributed computing resources (e.g., in cloud-based computing architecture). Memory/memories 206 may store instructions, parameters, data structures, etc., for use/execution by processor(s) 204 to perform functions described herein.

In an example, occupancy monitoring system 130 can optionally include one or more of an occupancy information obtaining component 210 for obtaining occupancy information from, or based on data or images from, one or more sensors 202, a weight applying component 212 for applying a weight to the occupancy information obtained based on information from the one or more sensors 202, an occupancy information computing component 214 for computing occupancy information based on the occupancy information received from multiple sensors 202, and/or a sensor calibrating component 216 for updating one or more parameters of a sensor 202 based on occupancy information received from another sensor 202.

In an example, occupancy monitoring system 130 can communicate with other devices or systems, such as sensor(s) 202, control system(s) 110, an automation system 220, an emergency services system 222, an AI component 224, etc., which may occur via a network 226 or other connection or coupling with the other devices or systems. For example, the automation system 220 can control one or more automated components for the establishment 100, such as an automated building management component that manages building security, alarms, HVAC systems, lighting, etc. In another example, emergency services system 222 can provide information to emergency services personnel, such as fire departments, ambulance, police, etc. to alert of potential dangerous situations or other emergencies in the establishment 100. In addition, in an example, AI component 224 can store one or more AI models 228, which can be accessed for detecting persons in one or more images received from one or more sensors 202, such as in thermal images, depth images, etc.

In an example, occupancy monitoring system 130 can receive thermal images from a thermal sensor monitoring the area 102, depth images from an ultra-wide band radar monitoring the area 102, etc., and occupancy information obtaining component 210 can detect one or more persons, or a count of people, in the thermal images and/or depth images. For example, occupancy information obtaining component 210 can utilize the AI component 224 to detect human heat signatures in a thermal image based on one or more trained AI models 228, to detect human outlines or other characteristics in a depth image based on one or more trained AI models 228, to detect heat signatures and corresponding outlines based on both of the thermal images and depth images, the combination of which can be input into one or more AI models 228 to detect people, etc. In one example, AI component 224 can use an object detector based on a machine learning (ML) model trained to detect certain objects, such as human signatures, outline, or other features, in an image. In one example, AI component 224 can use a generative adversarial network (GAN), which can include a ML model in which two neural networks (a generator and a discriminator) that compete with each other by using deep learning methods to become more accurate in their predictions. In other examples, AI component 224 can bypass the GAN (e.g., for a different neural network used), or can bypass one of the generator or discriminator (e.g., assuming they are well trained) in detecting bounding boxes that correspond to persons in the video feed.

In any case, for example, occupancy information obtaining component 210 can obtain one or more occupancy information (e.g., counts of people) from data based on each of multiple sensors 202, and occupancy information computing component 214 can determine a final occupancy count or other occupancy information based on combining the occupancy information from multiple sensors 202. In one example, weight applying component 212 can apply a weight to each of the occupancy information, where the weight can be based on a type of sensor 202 from which the occupancy information is received or determined. Occupancy monitoring system 130, in one example, can provide the occupancy information to the automation system 220, emergency services system 222, and/or the like, e.g., along with an indication of the area 102 to which the information corresponds, for further processing.

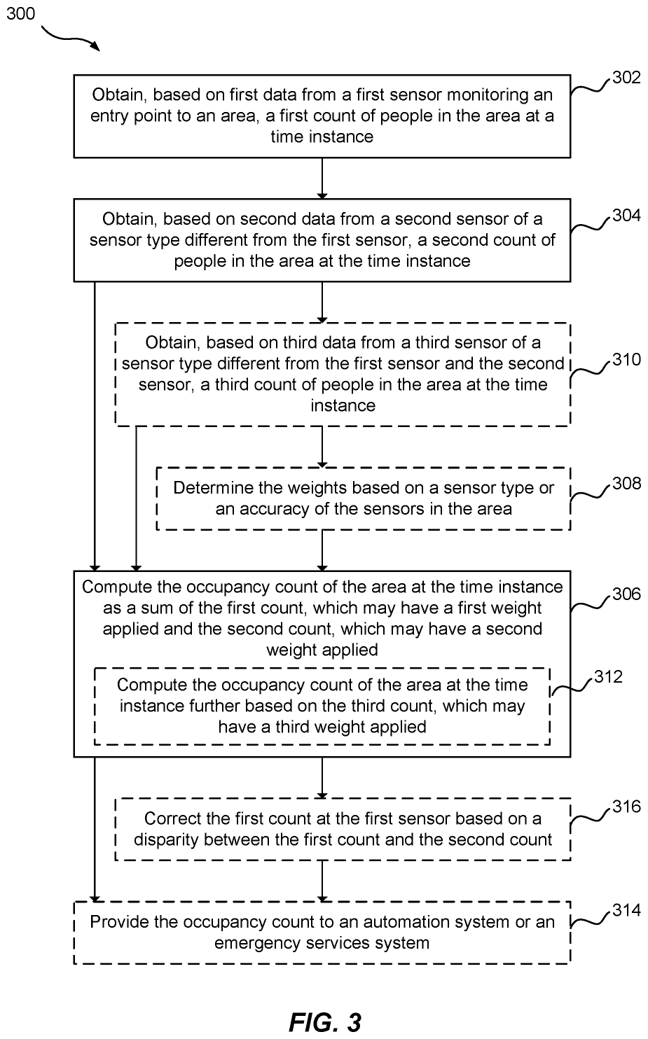

Referring to FIG. 3, an example of a method 300 for computing occupancy count of an area based on information from multiple sensors is depicted. The operations of the method 300 may be performed by one or more modules or components of the occupancy monitoring system 130, as described herein.

At 302, the method 300 may include obtaining, based on first data from a first sensor monitoring an entry point to an area, a first count of people in the area at a time instance. In an example, occupancy information obtaining component 210, e.g., in conjunction with the one or more processors 204, memory/memories 206, occupancy monitoring system 130, etc., can obtain, based on first data from the first sensor monitoring the entry point to the area, the first count of people in the area at the time instance. For example, occupancy information obtaining component 210 can obtain the first count from the first sensor directly or from an associated control system, which may be a sensor 202, sensor 106, second sensor 114, third sensor 118, etc., where the sensors or control systems are capable of generating occupancy monitoring information including a count of people and communicating the information to other nodes, such as occupancy monitoring system 130. For example, the first sensor can be a LIDAR sensor, where the LIDAR sensor or an associated control system maintains a count of people entering and/or exiting the area 102.

In another example, occupancy information obtaining component 210 can obtain the first count of people at least in part by computing the count based on other information received from the first sensor. For example, where the first sensor is a thermal sensor, occupancy monitoring system 130 can receive thermal images from the thermal sensor, and occupancy information obtaining component 210 can obtain the first count from the thermal images. For example, occupancy information obtaining component 210 can provide the thermal images as input to one or more AI models to detect human signature(s) in the thermal images, which can include providing the thermal images to AI component 224 as input to one or more AI models 228. The one or more AI models 228 can output an indication of one or more human signatures detected in the thermal images, a count of human signatures detected in the thermal images, etc. Occupancy information obtaining component 210 can determine the first count based on the output from the AI component 224 for the thermal images.

Similarly, in an example, where the first sensor is an ultra-wide band radar (or other radar) sensor, occupancy monitoring system 130 can receive depth images from the radar sensor, and occupancy information obtaining component 210 can obtain the first count from the depth images. For example, occupancy information obtaining component 210 can provide the depth images to AI component 224 as input to one or more AI models 228 for detecting outlines of one or more persons in the depth images. Occupancy information obtaining component 210 can determine the first count based on the output from the AI component 224 for the depth images.

At 304, the method 300 may include obtaining, based on second data from a second sensor of a sensor type different from the first sensor, a second count of people in the area at the time instance. In an example, occupancy information obtaining component 210, e.g., in conjunction with the one or more processors 204, memory/memories 206, occupancy monitoring system 130, etc., can obtain, based on second data from the second sensor of a sensor type different from the first sensor, the second count of people in the area at the time instance. For example, occupancy information obtaining component 210 can obtain the second count from the second sensor directly or from an associated control system, which may be a sensor 202, sensor 106, second sensor 114, third sensor 118, etc., where the sensors or control systems are capable of generating occupancy monitoring information including a count of people and communicating the information to other nodes, such as occupancy monitoring system 130. In another example, occupancy information obtaining component 210 can obtain the second count of people at least in part by computing the count based on other information received from the second sensor (e.g., based on thermal images, radar images, etc., as described above).

At 306, the method 300 may include computing the occupancy count of the area at the time instance as a sum of the first count, which may have a first weight applied and the second count, which may have a second weight applied. In an example, occupancy information computing component 214, e.g., in conjunction with the one or more processors 204, memory/memories 206, occupancy monitoring system 130, etc., can compute the occupancy count of the area at the time instance as the sum of the first count, which may have the first weight applied, and the second count, which may have the second weight applied. For example, weight applying component 212 can apply a weight to each of the counts obtained based on information from the sensors, and can occupancy information computing component 214 add the weight applied counts to compute the occupancy count. For example, the sum of the weights can be one—e.g., for two sensors, the weights may be 0.6 and 0.4, or 0.5 and 0.5, or 0.24 and 0.76, etc. The weights may be fixed or otherwise specified for the associated sensor data in a configuration, or can be dynamic or automatically determined.

At 308, the method 300 may optionally include determining the weights based on a sensor type or an accuracy of the sensors in the area. In an example, weight applying component 212, e.g., in conjunction with the one or more processors 204, memory/memories 206, occupancy monitoring system 130, etc., can determine the weights (e.g., a weight for each sensor or associated obtained occupancy monitoring information), which can be based on a sensor type or an accuracy of the sensors in the area 102. For example, weight applying component 212 can determine a weight for a sensor based on a type of the sensor, based on an environment within which the sensor is being used, based on a determined accuracy of the sensor, based on other sensors being used in the area 102 (e.g., based on the other sensor types or accuracy), etc. In an example, where a thermal sensor is being used and temperature fluctuation in the area 102 is detected as achieving a threshold fluctuation, the temperature fluctuation may lead to inaccurate human detection in the thermal images. In this example, weight applying component 212 may determine a smaller weight for the thermal sensor than in other environments where temperature fluctuation is more steady. In one example, weight applying component 212 may determine the smaller weight based also on the presence of multiple other sensors (e.g., multiple radar sensors, or other types of sensors that may be more accurate in the temperature fluctuation environment).

In another example, where a radar sensor is being used and reflective vests are used in the area 102, the reflective vests may lead to inaccurate depth images in the area 102. In this example, weight applying component 212 may determine a smaller weight for the radar sensor than in other environments where the depth images are more reliable. In one example, weight applying component 212 may determine the smaller weight based also on the presence of multiple other sensors (e.g., multiple thermal sensors, or other types of sensors that may be more accurate in environments having reflective vests).

In one example, weight applying component 212 can determine the weights based on the sensor type, based on configuration performed at deployment or later updated, etc. In another example, weight applying component 212 can adaptively update the weights based on detecting parameters via the sensors or other devices. For example, weight applying component 212 may receive input from a thermometer that measures temperature fluctuation, and can adjust weights of the sensors based on comparing temperature fluctuation to one or more thresholds. In another example, as described further herein, sensor calibrating component 216 can calibrate a sensor based on detecting discrepancy between occupancy monitoring information, or counts of people, received from other sensors. Based on detecting a number or amount of discrepancy of a sensor as being beyond a threshold, sensor calibrating component 216 can accordingly decrease a weight for data from an associated sensor, in some examples.

At 310, the method 300 may optionally include obtaining, based on third data from a second sensor of a sensor type different from the first sensor and the second sensor, a third count of people in the area at the time instance. In an example, occupancy information obtaining component 210, e.g., in conjunction with the one or more processors 204, memory/memories 206, occupancy monitoring system 130, etc., can obtain, based on third data from the third sensor of a sensor type different from the first sensor and the second sensor, the third count of people in the area at the time instance. For example, occupancy information obtaining component 210 can obtain the third count from the third sensor directly or from an associated control system, which may be a sensor 202, sensor 106, second sensor 114, third sensor 118, etc., where the sensors or control systems are capable of generating occupancy monitoring information including a count of people and communicating the information to other nodes, such as occupancy monitoring system 130. In another example, occupancy information obtaining component 210 can obtain the third count of people at least in part by computing the count based on other information received from the third sensor (e.g., based on thermal images, radar images, etc., as described above).

In this example, computing the occupancy count at 306, may optionally include, at 312, computing the occupancy count of the area at the time instance further based on the third count, which may have a third weight applied. In an example, occupancy information computing component 214, e.g., in conjunction with the one or more processors 204, memory/memories 206, occupancy monitoring system 130, etc., can compute the occupancy count of the area at the time instance further based on the third count, which may have the third weight applied. For example, occupancy information computing component 214 can include the third count in the sum as well, where the first, second, and third weights can add up to one. Additional sensors can be considered and used in the calculation as well; examples are described herein using two or three sensors for ease of explanations. In addition, for example, multiple sensors of the same sensor type can be used, and can use the same or a different assigned weight. For example, as described above, though a same sensor type can be used, one sensor may be more susceptible to inaccuracies based on various factors, such as factors of a part of the area where the sensor is deployed, obstructions in the view of the sensor, etc. In some examples, weight applying component 212 can be capable of adjusting the weight of a sensor to account for the inaccuracies, whether explicitly configured by personnel, or based on automated detection of the inaccuracies or environmental factors, etc.

In an example, two or more of the first data, the second data, or the third data (or additional data from additional sensors) can be provided to the AI component 224 as multiple inputs to one or more AI models 228. In this regard, for example, one or more of the data used in computing the occupancy count at 306 can be obtained based on providing multiple inputs to the AI component 224. For example, occupancy information obtaining component 210 can provide a thermal image and an associated depth image (e.g., of a similar time instance) to AI component 224 for obtaining information regarding detected humans in the images or a count of humans detected in the images. In this example, one or more AI models 228 can detect humans based on features of thermal and depth images considered together.

Once the occupancy count is computed, at 314, the method 300 may optionally include providing the occupancy count to an automation system or an emergency services system. In an example, occupancy monitoring system 130, e.g., in conjunction with the one or more processors 204, memory/memories 206, etc., can provide the occupancy count to an automation system (e.g., automation system 220) or an emergency services system (e.g., emergency services system 222). For example, occupancy monitoring system 130 can provide the occupancy count, a confidence score in the occupancy count (which may be based on weights for the sensors or parameters or factors considered when determining the weights, etc.), and/or the like to the automation system 220 or emergency services system 222 via network 226. In an example, as described, automation system 220 can use the occupancy count to control one or more automated systems, such as an HVAC system, lighting system, access control system (e.g., to limit a number of occupants in the area), etc. In another example, as described, emergency services system 222 can use the occupancy count in assisting or locating people during or after an emergency situation, such as a fire, active shooter, or other emergency scenarios.

In some examples, computing high confidence occupancy information using concepts described herein can assist in development and adoption of smart and autonomous buildings. For example, the high accuracy occupancy counts can allow for improved energy efficiency through optimization of energy usage of a building's HVAC systems, enhanced security and safety through detection and response to potential security threats or emergencies and/or detection of unauthorized entry into restricted areas, improved space utilization through optimizing the use of space within buildings and/or enabling informed decisions on resource allocation layouts to meet occupants needs, etc. or increased productivity through providing insight into how the building is being used and/or supporting workspace optimization and more conducive work environments.

In addition, in accordance with aspects described herein, people can use doors to enter rooms, buildings, etc. Sensors can provide information on quantity and location of occupants and confidence of sensor data can be calculated in real time. Multi-sensor data can be aggregated in multiple ingress/egress situations, and the high confidence data can be used to better manage HVAC, cleaning services, space utilization planning, etc. The information can be used in security systems to trigger an alarm when maximum occupancy has been reached. In emergency situations data can be used to safely guide people away from volatile areas and out of the facility as needed, identify location and number of people trapped by the emergency, provide police/rescue services information on where people are including motion of individuals within a space, etc. In addition, in some examples, where people break into an area, sensors can provide information on location, number of invaders, and the high accuracy occupancy information can be used to autonomously alert security operations center (SOC), enable taking appropriate critical actions, call police, isolate intruders (e.g., using an access control system to lock doors), use information to guide people away from intrusion site, etc.

At 316, the method 300 may optionally include correcting the first count at the first sensor based on a disparity between the first count and the second count. In an example, sensor calibrating component 216, e.g., in conjunction with the one or more processors 204, memory/memories 206, occupancy monitoring system 130, etc., can correct the first count at the first sensor based on a disparity between the first count and the second count. For example, where the first sensor is a LIDAR sensor, the LIDAR sensor may lose count if power is temporarily lost to the LIDAR sensor while there are people in the area 102. When the power is restored, the LIDAR sensor may reset to zero, and thus may be off by the number of people in the area 102 when the count is reset. In an example, where the second (and/or third, and/or additional) sensor is determined to have a different count and the count is more reliable, sensor calibrating component 216 can use the count from the more reliable sensor to correct the count at the LIDAR sensor, which may include sensor calibrating component 216 communicating the updated count to the LIDAR sensor or an associated control system 110. In an example, sensor calibrating component 216 can perform such corrections to any sensor that supports updating the count or parameter used in determining a count, etc. In one example, where occupancy information obtaining component 210 determines the count based on information received from a given sensor, sensor calibrating component 216 can cause or configure occupancy information obtaining component 210 to apply correction when determining the count for the given sensor, which may include communicating an adjustment value to occupancy information obtaining component 210 for applying to the count.

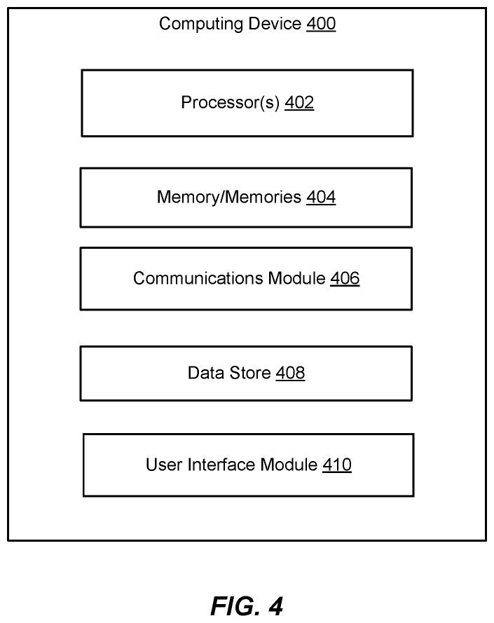

Referring to FIG. 4, a computing device 400 may implement all or a portion of the functionality described in FIGS. 1-3. For example, the computing device 400 may be or may include at least a portion of the occupancy monitoring system 130, or any other module or component described herein with reference to FIGS. 1-3. The computing device 400 may include one or more processors 402 which may be configured to execute or implement software, hardware, and/or firmware modules that perform some or all of the functionality described herein with reference to FIGS. 1-3. For example, the processor(s) 402 may be configured to execute or implement software, hardware, and/or firmware modules that perform some or all of the functionality described herein with reference to the occupancy monitoring system 130, or any other module or component described herein with reference to FIGS. 1-3.

The processor(s) 402 may be a micro-controller, an application-specific integrated circuit (ASIC), or a field-programmable gate array (FPGA), and/or may include a single or multiple set of processors or multi-core processors. Moreover, the processor(s) 402 may be implemented as an integrated processing system and/or a distributed processing system. The computing device 400 may further include memory/memories 404, such as for storing local versions of applications being executed by the processor(s) 402, related instructions, parameters, etc. The memory/memories 404 may include a type of memory usable by a computer, such as random access memory (RAM), read only memory (ROM), tapes, magnetic discs, optical discs, volatile memory, non-volatile memory, and any combination thereof. Additionally, the processor(s) 402 and the memory/memories 404 may include and execute an operating system executing on the processor(s) 402, one or more applications, display drivers, etc., and/or other modules or components of the computing device 400.

Further, the computing device 400 may include a communications module 406 that provides for establishing and maintaining communications with one or more other devices, parties, entities, etc. utilizing hardware, software, and services. The communications module 406 may carry communications between modules on the computing device 400, as well as between the computing device 400 and external devices, such as devices located across a communications network and/or devices serially or locally connected to the computing device 400. In an aspect, for example, the communications module 406 may include one or more buses, and may further include transmit chain modules and receive chain modules associated with a wireless or wired transmitter and receiver, respectively, operable for interfacing with external devices.

Additionally, the computing device 400 may include a data store 408, which can be any suitable combination of hardware and/or software, that provides for mass storage of information, databases, and programs. For example, the data store 408 may be or may include a data repository for applications and/or related parameters not currently being executed by processor(s) 402. In addition, the data store 408 may be a data repository for an operating system, application, display driver, etc., executing on the processor 402, and/or one or more other modules of the computing device 400.

The computing device 400 may also include a user interface module 410 operable to receive inputs from a user of the computing device 400 and further operable to generate outputs for presentation to the user (e.g., via a display interface to a display device). The user interface module 410 may include one or more input devices, including but not limited to a keyboard, a number pad, a mouse, a touch-sensitive display, a navigation key, a function key, a microphone, a voice recognition module, or any other mechanism capable of receiving an input from a user, or any combination thereof. Further, the user interface module 410 may include one or more output devices, including but not limited to a display interface, a speaker, a haptic feedback mechanism, a printer, any other mechanism capable of presenting an output to a user, or any combination thereof.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, a processor, at least one processor, and/or one or more processors, individually or in combination, configured to perform or operable for performing a plurality of actions is meant to include at least two different processors able to perform different, overlapping or non-overlapping subsets of the plurality actions, or a single processor able to perform all of the plurality of actions. In one non-limiting example of multiple processors being able to perform different ones of the plurality of actions in combination, a description of a processor, at least one processor, and/or one or more processors configured or operable to perform actions X, Y, and Z may include at least a first processor configured or operable to perform a first subset of X, Y, and Z (e.g., to perform X) and at least a second processor configured or operable to perform a second subset of X, Y, and Z (e.g., to perform Y and Z). Alternatively, a first processor, a second processor, and a third processor may be respectively configured or operable to perform a respective one of actions X, Y, and Z. It should be understood that any combination of one or more processors each may be configured or operable to perform any one or any combination of a plurality of actions.

As used herein, a memory, at least one memory, and/or one or more memories, individually or in combination, configured to store or having stored thereon instructions executable by one or more processors for performing a plurality of actions is meant to include at least two different memories able to store different, overlapping or non-overlapping subsets of the instructions for performing different, overlapping or non-overlapping subsets of the plurality actions, or a single memory able to store the instructions for performing all of the plurality of actions. In one non-limiting example of one or more memories, individually or in combination, being able to store different subsets of the instructions for performing different ones of the plurality of actions, a description of a memory, at least one memory, and/or one or more memories configured or operable to store or having stored thereon instructions for performing actions X, Y, and Z may include at least a first memory configured or operable to store or having stored thereon a first subset of instructions for performing a first subset of X, Y, and Z (e.g., instructions to perform X) and at least a second memory configured or operable to store or having stored thereon a second subset of instructions for performing a second subset of X, Y, and Z (e.g., instructions to perform Y and Z). Alternatively, a first memory, and second memory, and a third memory may be respectively configured to store or have stored thereon a respective one of a first subset of instructions for performing X, a second subset of instruction for performing Y, and a third subset of instructions for performing Z. It should be understood that any combination of one or more memories each may be configured or operable to store or have stored thereon any one or any combination of instructions executable by one or more processors to perform any one or any combination of a plurality of actions. Moreover, one or more processors may each be coupled to at least one of the one or more memories and configured or operable to execute the instructions to perform the plurality of actions. For instance, in the above non-limiting example of the different subset of instructions for performing actions X, Y, and Z, a first processor may be coupled to a first memory storing instructions for performing action X, and at least a second processor may be coupled to at least a second memory storing instructions for performing actions Y and Z, and the first processor and the second processor may, in combination, execute the respective subset of instructions to accomplish performing actions X, Y, and Z. Alternatively, three processors may access one of three different memories each storing one of instructions for performing X, Y, or Z, and the three processor may in combination execute the respective subset of instruction to accomplish performing actions X, Y, and Z. Alternatively, a single processor may execute the instructions stored on a single memory, or distributed across multiple memories, to accomplish performing actions X, Y, and Z.

What is claimed is:

1. A computer-implemented method for obtaining an occupancy count of an area, comprising:
obtaining, based on first data from a first sensor monitoring an entry point to the area, a first count of people in the area at a time instance, wherein the first sensor is a light detecting and ranging (LIDAR) sensor;
obtaining, based on second data captured by a second sensor of a sensor type other than LIDAR, a second count of people in the area at the time instance; and
computing the occupancy count of the area at the time instance as a sum of the first count having a first weight applied and the second count having a second weight applied.

2. The computer-implemented method of claim 1, further comprising:
determining the first weight based on a first accuracy of the first sensor in the area; and
determining the second weight based on a second accuracy of the second sensor in the area.

3. The computer-implemented method of claim 1, wherein the second sensor includes a thermal sensor that captures thermal images of the area, and wherein obtaining the second count of people in the area is based at least in part on detecting, using a trained artificial intelligence model, human signatures in at least one thermal image of the area that is associated with the time instance.

4. The computer-implemented method of claim 3, further comprising capturing, by an ultra-wide band radar, radar data of the area that is associated with the time instance, wherein detecting the human signatures is further based on the radar data.

5. The computer-implemented method of claim 3, further comprising obtaining, based on data captured by an ultra-wide band radar, a third count of people in the area at the time instance, wherein computing the occupancy count is further based at least in part on the third count having a third weight applied.

6. The computer-implemented method of claim 1, wherein the second sensor include an ultra-wide band radar that captures radar data of the area, and wherein obtaining the second count of people in the area is based at least in part on detecting, using a trained artificial intelligence model, human outlines in the radar data that is associated with the time instance.

7. The computer-implemented method of claim 1, further comprising correcting the first count at the first sensor based on a disparity between the first count and the second count.

8. The computer-implemented method of claim 1, further comprising providing the occupancy count to an automation system.

9. The computer-implemented method of claim 1, further comprising providing the occupancy count to an emergency services system.

10. An apparatus, comprising:
one or more memories configured to store instructions; and
one or more processors communicatively coupled with the one or more memories, wherein the one or more processors are configured to:
obtain, based on first data from a first sensor monitoring an entry point to an area, a first count of people in the area at a time instance, wherein the first sensor is a light detecting and ranging (LIDAR) sensor;
obtain, based on second data captured by a second sensor of a sensor type other than LIDAR, a second count of people in the area at the time instance; and
compute an occupancy count of the area at the time instance as a sum of the first count having a first weight applied and the second count having a second weight applied.

11. The apparatus of claim 10, wherein the one or more processors are configured to:
determine the first weight based on a first accuracy of the first sensor in the area; and
determine the second weight based on a second accuracy of the second sensor in the area.

12. The apparatus of claim 10, wherein the second sensor includes a thermal sensor that captures thermal images of the area, and wherein the one or more processors are configured to obtain the second count of people in the area based at least in part on detecting, using a trained artificial intelligence model, human signatures in at least one thermal image of the area that is associated with the time instance.

13. The apparatus of claim 12, wherein the one or more processors are configured to capture, by an ultra-wide band radar, radar data of the area that is associated with the time instance, wherein the one or more processors are configured to detect the human signatures further based on the radar data.

14. The apparatus of claim 12, wherein the one or more processors are configured to obtain, based on data captured by an ultra-wide band radar, a third count of people in the area at the time instance, wherein the one or more processors are configured to compute the occupancy count further based at least in part on the third count having a third weight applied.

15. The apparatus of claim 10, wherein the second sensor include an ultra-wide band radar that captures radar data of the area, and wherein the one or more processors are configured to obtain the second count of people in the area based at least in part on detecting, using a trained artificial intelligence model, human outlines in the radar data that is associated with the time instance.

16. The apparatus of claim 10, wherein the one or more processors are configured to correct the first count at the first sensor based on a disparity between the first count and the second count.

17. The apparatus of claim 10, wherein the one or more processors are configured to provide the occupancy count to an automation system.

18. The apparatus of claim 10, wherein the one or more processors are configured to provide the occupancy count to an emergency services system.

19. One or more computer-readable media storing instructions, executable by one or more processors, for obtaining an occupancy count of an area, the instructions comprising instructions for:
obtaining, based on first data from a first sensor monitoring an entry point to the area, a first count of people in the area at a time instance, wherein the first sensor is a light detecting and ranging (LIDAR) sensor;
obtaining, based on second data captured by a second sensor of a sensor type other than LIDAR, a second count of people in the area at the time instance; and
computing the occupancy count of the area at the time instance as a sum of the first count having a first weight applied and the second count having a second weight applied.

20. The one or more computer-readable media of claim 19, the instructions further comprising instructions for:
determining the first weight based on a first accuracy of the first sensor in the area; and
determining the second weight based on a second accuracy of the second sensor in the area.
